(19) United States
(12) Patent Application Publication
(10) Pub. No.: US 2023/0066150 A1
(43) Pub. Date: Mar. 2, 2023

(54) RARE-EARTH MAGNET

(71) Applicants: LG ELECTRONICS INC., Seoul (KR); NATIONAL INSTITUTE FOR MATERIALS SCIENCE, Ibaraki (JP)

(72) Inventors: Sunyong SONG, Seoul (KR); Seok NAMKUNG, Seoul (KR); Xin TANG, Ibaraki (JP); Hossein SEPEHRIAMIN, Ibaraki (JP); Tadakatsu OHKUBO, Ibaraki (JP); Kazuhiro HONO, Ibaraki (JP); Jiangnan LI, Ibaraki (JP)

(73) Assignees: LG ELECTRONICS INC., Seoul (KR); NATIONAL INSTITUTE FOR MATERIALS SCIENCE, Ibaraki (JP)

(21) Appl. No.: 17/797,976

(22) PCT Filed: Feb. 6, 2020
(86) PCT No.: PCT/KR2020/001708

§ 371 Date: Aug. 5, 2022

(51) Int. Cl. H01F 1/057

(52) U.S. Cl. CPC H01F 1/057

(57) ABSTRACT

A rare-earth magnet according to an embodiment of the present invention comprises: a rare-earth magnet precursor including a composition of (R1(1-x)R2x)yFe(100-y-z-v-w)CozBvTMlw in which R1 comprises at least one of Nd or Pr, and R2 comprises Ce; and a diffusion metal including a composition of (LRE(100-p-q)HREp)TM2q, and diffused on the surface of the rare-earth magnet precursor, wherein the LRE in the diffusion metal can comprise light rare earth including Y, and the HRE can comprise heavy rare earth.

### BACKGROUND OF THE DISCLOSURE

### 1. Field of the Disclosure

The present disclosure relates to a rare-earth magnet. More particularly, the present disclosure relates to a rare-earth magnet, in which a material diffused on the surface of a rare-earth magnet precursor is controlled.

### 2. Description of the Related Art

Among R—Fe—B based rare-earth magnets, 00—Fe—B based rare-earth magnet is the most representative. In the Nd—Fe—B based rare-earth magnet, various attempts have been made to improve magnetic properties.

For example, since the conventional Nd—Fe—B based sintered rare-earth magnet has a limitation in reducing a grain size and is disadvantageous in improving a coercive force, research on various methods for improving the coercive force is being conducted.

### SUMMARY

The technical problems to be solved by the present disclosure will be described as follows.

First, the present disclosure is to provide a rare-earth magnet capable of realizing excellent magnetic properties.

Further, the present disclosure is to solve all problems that may be caused or predicted from the prior art, in addition to the above-described technical problems. A rare-earth magnet according to the present disclosure can control a material diffused on a surface of a rare-earth magnet precursor.

The rare-earth magnet according to the present disclosure may control the material diffused on the surface of the rare-earth magnet precursor.

Specifically, the rare-earth magnet includes a rare-earth magnet precursor including a 30 composition of(R1₍₁₋ₓ₎R2ₓ)yFe_{(100-y-Z-w)}CozBvTMlw in which R1 includes At least one ofNd or Pr, and R2 includes Ce, and a diffusion metal including a composition of (LRE_{(100-p- q)}HREₚ)TM2_{q}, and diffused on the surface of the rare-earth magnet precursor.

The LRE in the diffusion metal comprises light rare earth, and the HRE comprises heavy rare earth.

The LRE may include at least one of Nd, Pr, Ce, La, or Y.

The HRE may include at least one of Dy or Th.

The TM2 may include at least one of Ti, Ga, Zn, Si, Al, Nb, Zr, Mn, V, W, Ta, Ge, Cu, Cr, Hf, Mo, P, C, Mg, Ag, or Au.

In the composition of the diffusion metal, the p may be 5 to 50.

In the composition of the diffusion metal, the q may be greater than 10 and less than 40.

The diffusion metal may be 6 to 12 parts by weight based on 100 parts by weight of the rare-earth magnet precursor.

The TM1 may include at least one of Ti, Ga, Zn, Si, Al, Nb, Zr, Mn, V, W, Ta, Ge, Cu, Cr, Hf, Mo, P, C, Mg, Ag, or Au.

The x may be 0.2 to 0.3.

The y may be 12.52 to 13.61.

The z may be 3 to 5.

The v may be 5 to 10.

The w may be 0.5 to 1.

The rare-earth magnet precursor may be a hot deformed magnet.

### EFFECTS OF THE DISCLOSURE

A rare-earth magnet according to the present disclosure configured as described above is as follows.

The rare-earth magnet of the present disclosure can effectively improve a coercive force and simultaneously minimize a reduction in residual magnetization by controlling a diffusion material diffused on the surface of a rare-earth magnet precursor, thus improving magnetic properties.

### DETAILED DESCRIPTION OF THE PREFERRED EMBODIMENTS

Advantages and features of the present disclosure and a method of achieving them will become apparent with reference to the following embodiments.

The present disclosure will be defined by the scope of claims. If there is a separate description for the meaning of terms in the specification, the meaning of the terms will be defined by the above description. Like reference numerals refer to like elements throughout the specification.

The rare-earth magnet of the present disclosure may include a rare-earth magnet precursor including a rare-earth element and a diffusion material diffused on a surface of the rare-earth magnet precursor.

The rare-earth magnet according to an embodiment of the present disclosure may further include the diffusion material in the rare-earth magnet precursor, thus improving a coercive force and minimizing a reduction in residual magnetization, thereby improving magnetic properties.

Specifically, the rare-earth magnet precursor may be a rare earth element (R)—Fe—B based magnet, and be a magnet subjected to hot deformation treatment.

The rare-earth magnet precursor may have the composition of (R1₍₁₋ₓ₎R2ₓ)yFe_{(100-y-z-v-w)}CozBvTMlw.

R1 may include at least one ofNd or Pr. That is, R1 may include only either Nd or Pr, and may include both Nd and Pr.

When including both Nd and Pr, R1 may have the composition of (Nd(i.iPrs), and S may be 0 or more and less than 1.

Meanwhile, R2 may include Ce, and TM1 may include at least one of Ti, Ga, Zn, Si, Al, Nb, Zr, Mn, V, W, Ta, Ge, Cu, Cr, Hf, Mo, P, C, Mg, Ag, or Au.

In the composition of the rare-earth magnet precursor, x is a relative molar ratio of R1 to R2, and x may be 0.2 to 0.3.

That is, the rare-earth magnet precursor may reduce the usage of Nd and Pr, which are relatively expensive, by controlling the range of R2 substituting for R1 to 20% to 30%, thus reducing production cost.

In addition, the rare-earth magnet precursor may compensate for the deterioration of magnetic properties, which may occur due to the substitution of R2 for R1, by the hot deformation treatment that will be described below.

In the composition of the rare-earth magnet precursor, y is a content ratio of (R1₍₁₋ₓ₎R2ₓ) as at %. y may be 12.52 to 13.61.

In the composition of the rare-earth magnet precursor, z is a content ratio of Co as at %. z may be3 to 5.

In the composition of the rare-earth magnet precursor, v is a content ratio of B as at %. v may be 5 to 10.

In the composition of the rare-earth magnet precursor, w is a content ratio of TM1 as at %. w maybe 0.5 to 1.

The rare-earth magnet precursor may be a hot deformed magnet. In the rare-earth magnet according to an embodiment of the present disclosure, the rare-earth magnet precursor may be subjected to hot deformation treatment instead of sintering.

Therefore, the magnetic powder of the rare-earth magnet precursor is densified, and grains are diffused and grown to a certain size and are transformed into a plate shape.

Consequently, the grains have anisotropy because an easy magnetization direction is aligned in one direction due to crystallographic characteristics.

A specific hot deformation process will be described later.

The rare-earth magnet according to an embodiment of the present disclosure may include a diffusion material diffused on the surface of the rare-earth magnet precursor, thus improving a coercive force and minimizing a reduction in residual magnetization due to interfacial diffusion.

Specifically, the rare-earth magnet may include a diffusion metal having the composition of (LRE_{(100-p-q)}HREp)TM2_{q}, as the diffusion material.

That is, the rare-earth magnet according to an embodiment of the present disclosure may not uniformly include a material having the composition of (LRE_{(100-p-q)}HREₚ)TM2_{q} in the rare-earth magnet, but may diffuse a portion of the material from the surface to the inside thereof.

In the composition of (LRE_{(100-p-q)}HREₚ)TM2_{q}, the LRE may include light rare earth, and the HRE may include heavy rare earth.

Specifically, the LRE may include at least one of Nd, Pr, Ce, La, or Y (Yttrium), and the HRE may include at least one of Dy or Th.

Moreover, TM2 may include at least one of Ti, Ga, Zn, Si, Al, Nb, Zr, Mn, V, W, Ta, Ge, Cu, Cr, Hf, Mo, P, C, Mg, Ag, or Au.

When the diffusion metal is diffused on the surface of the rare-earth magnet precursor, the rare-earth magnet according to an embodiment of the present disclosure may be positioned at the interface of a magnetic phase to be magnetically insulated, thus suppressing the generation and transfer of a reverse domain of the magnetic phase, and thereby improving the coercive force of the rare-earth magnet.

In addition, the rare-earth magnet according to an embodiment of the present disclosure may simultaneously control the composition ratio and weight part of the diffusion metal so as to efficiently improve magnetic properties.

Specifically, in the composition of (LRE(_{I}oo.ₚHREₚ)TM2_{q}, p may be controlled to about 5 to 50 as at %.

That is, the rare-earth magnet according to an embodiment of the present disclosure can effectively improve the coercive force of the rare-earth magnet and simultaneously minimize a reduction in residual magnetization, by controlling the molar ratio of the heavy rare earth contained in the diffusion metal to a certain range.

TABLE 1

| | | |
|---|---|---|
| Composition | ΔBr (kG) | ΔHc (kOe) |

| | | | | | |
|---|---|---|---|---|---|
| Ref | Nd₈₀Cu₂₀ | −1.9 | (−12%) | +7.2 | (+65.4%) |
| 1 | Nd₇₅Dy₅Cu₂₀ | −0.8 | (−5.4%) | +6 | (+54.5%) |
| 2 | Nd₇₀Dy₁₀Cu₂₀ | −0.7 | (−4.7%) | +7.2 | (+65.4%) |
| 3 | Nd₆₀Dy₂₀Cu₂₀ | −0.7 | (−4.7%) | +7.8 | (+70.9%) |
| 4 | Nd₅₀Dy₃₀Cu₂₀ | −0.6 | (−4.1%) | +8 | (+72.7%) |
| 5 | Nd₄₀Dy₄₀Cu₂₀ | −0.7 | (−4.7%) | +8 | (+72.7%) |
| 6 | Nd₃₀Dy₅₀Cu₂₀ | −0.76 | (−5.1%) | +8.5 | (+77.2%) |
| 7 | Nd₂₀Dy₆₀Cu₂₀ | −1.6 | (−10.8%) | +8.8 | (+80%) |

Table 1 shows a change in coercive force and a change in residual magnetization of the rare-earth magnet according to the ratio of the heavy rare earth contained in the diffusion metal.

Specifically, Ref. and experimental examples 1 to 7 of Table 1 show a change in coercive force and a change in residual magnetization of the rare-earth magnet when diffusing the diffusion metal having the compositions of Ref. and examples 1 to 7 of Table 1 on the surface of the rare-earth magnet precursor including the composition of (Nd_{0.75}Ce_{0.25})_{13.05}Fe_{76.19}Co_{4.31}B_{5.92}Ga_{0.53}.

In detail, this shows a change in coercive force and a change in residual magnetization according to the inclusion ratio of the heavy rare earth Dy.

Experimental example 7 is a case in which 60at % of heavy rare earth is contained, and is more excellent in the effect of improving the coercive force but is greatly reduced in a residual magnetization value compared to the experimental example of Ref.

On the other hand, experimental examples 1 to 6 are diffusion metals containing 5at % to 50at % of heavy rare earth. It can be seen that these examples realize more excellent effect of improving the coercive force and simultaneously minimize a reduction in residual magnetization compared to the experimental example of Ref., so that they can realize excellent magnetic properties.

Furthermore, the rare-earth magnet according to an embodiment of the present disclosure can improve the coercive force and simultaneously minimize a reduction in residual magnetization by controlling the diffusion amount of the diffusion metal.

TABLE 2

| | | |
|---|---|---|
| Diffusion amount | ΔBr (kG) | ΔHc (kOe) |

| | | | | | | |
|---|---|---|---|---|---|---|
| 1 | 15 | wt. % | −0.93 | (−6.3%) | +7.4 | (+67.2%) |
| 2 | 12 | wt. % | −0.6 | (−4.1%) | +8 | (+72.7%) |
| 3 | 9 | wt. % | −0.6 | (−4.1%) | +7 | (+63.6%) |
| 4 | 6 | wt. % | −0.2 | (−1.3%) | +6.3 | (+57.2%) |
| 5 | 3 | wt. % | −0.1 | (−0.6%) | +2.2 | (+20%) |

Table 2 shows a change in coercive force and a change in residual magnetization of the rare-earth magnet according to the weight part of the diffusion metal based on 100 parts by weight of the rare-earth magnet precursor.

Specifically, experimental examples 1 to 5 of Table 2 show a change in coercive force and a change in residual magnetization of the rare-earth magnet according to the diffused amount when diffusing the diffusion metal having the composition of NdsoDy3oCu2o on the surface of the rare-earth magnet precursor including the composition of (Nd_{0.75}Ce_{0.25})_{13.05}Fe_{76.19}Co_{4.31}B_{5.92} Ga_{0.53}.

In detail, this shows a change in coercive force and a change in residual magnetization according to the weight % (parts by weight) of the diffusion metal, and generally shows that the coercive-force improving effect tends to increase as the weight % of the diffusion metal increases.

However, in experimental example 5, the amount of the diffusion metal is small, so it is difficult to sufficiently diffuse the diffusion metal into the rare-earth magnet and thereby the degree of improving the coercive force is small. In experimental example 1, the coercive-force improvement is small and the residual magnetization reduction is large compared to the diffusion amount of the diffusion metal.

In contrast, experimental examples 2 to 4 are experimental examples in which the amount of the diffused diffusion metal is 6 parts by weight or more and less than 15 parts by weight.

In experimental examples 2 to 4, the amount of the diffused diffusion metal is controlled to 6 to 12 parts by weight, so that these examples realize more excellent effect of improving the coercive force and simultaneously minimize a reduction in residual magnetization compared to experimental example 1 and 5, thereby realizing excellent magnetic properties.

Meanwhile, the rare-earth magnet according to an embodiment of the present disclosure may control the molar ratio of TM2 included in the diffusion metal so as to efficiently improve the magnetic properties.

Specifically, in the composition of(LRE_{(100-p-q)}HREₚ)TM2_{q}, q may be controlled to be more than about 10 and less than about 40 as at %.

That is, the rare-earth magnet according to an embodiment of the present disclosure may control the molar ratio of TM2 included in the diffusion metal to a certain range, thus effectively improving the coercive force of the rare-earth magnet and simultaneously minimizing a reduction in residual magnetization.

TABLE 3

| | | |
|---|---|---|
| Composition | ΔBr (kG) | ΔHc (kOe) |

| | | | | | |
|---|---|---|---|---|---|
| 11 | Nd₅₄Dy₃₆Cu₁₀ | +0.1 | (+0.6%) | −0.1 | (−0.9%) |
| 2 | Nd₅₀Dy₃₀Cu₂₀ | −0.6 | (−4.1%) | +8 | (+72.7%) |
| 3 | Nd₄₂Dy₂₈Cu₃₀ | −0.74 | (−5%) | +7.9 | (+71.8%) |
| 4 | Nd₃₆Dy₂₄Cu₄₀ | −0.76 | (−5.1%) | +6.9 | (+62.7%) |

Table 3 shows a change in coercive force and a change in residual magnetization of the rare-earth magnet according to the ratio of TM2 included in the diffusion metal. Specifically, experimental examples 1 to 4 of Table 3 show a change in coercive force and a change in residual magnetization of the rare-earth magnet when diffusing 12 wt % of diffusion metal having the composition of examples 1 to 4 of Table 1 on the surface of the rare-earth magnet precursor including the composition of (Ndo.7sCeo.25)13.osFe76.19Co4.31B5.92Gao.53.

In detail, this shows a change in coercive force and a change in residual magnetization according to the inclusion ratio of TM2(Cu). In experimental example 1, the melting point of diffusion alloy is about 900 degrees or more. The diffusion of the diffusion alloy does not occur at 800 degrees, which is the diffusion temperature, so that the coercive force is reduced.

Each of experimental examples 2 and 3 improves the coercive force by 70% or more. In experimental example 4, as the amount of TM2(Cu) increases, the amount of diffused rare earth element is reduced, so that an increase in coercive force is relatively insufficient.

Therefore, by controlling the TM2 element contained in the diffusion metal of the rare-earth magnet according to an embodiment of the present disclosure to be more than 1Oat % and less than 40 at %, it can be seen that excellent coercive-force improving effect is realized and simultaneously a reduction in residual magnetization is minimized, thus resulting in excellent magnetic properties.

Although the present disclosure was described with reference to specific embodiments shown in the drawings, it is apparent to those skilled in the art that the present disclosure may be changed and modified in various ways without departing from the scope of the present disclosure, which is described in the following claims.

What is claimed is:

1. A rare-earth magnet comprising:
a rare-earth magnet precursor including a composition of (R1₍₁₋ₓ₎R2ₓ)yFe_{(100-y-z-v-w)}CozBvTMlw in which R1 comprises At least one of Nd or Pr, and R2 comprises Ce; and
a diffusion metal including a composition of(LRE_{(100-p-q)}HREₚ)TM2_{q}, and diffused on the surface of the rare-earth magnet precursor,
wherein the LRE in the diffusion metal comprises light rare earth, and the HRE comprises heavy rare earth.

2. The rare-earth magnet of claim 1, wherein the LRE comprises at least one ofNd, Pr, Ce, La, or Y.

3. The rare-earth magnet of claim 1, wherein the HRE comprises at least one of Dy or Th.

4. The rare-earth magnet of claim 1, wherein the TM2 comprises at least one of Ti, Ga, Zn, Si, Al, Nb, Zr, Mn, V, W, Ta, Ge, Cu, Cr, Hf, Mo, P, C, Mg, Ag, or Au.

5. The rare-earth magnet of claim 1, wherein in the composition of the diffusion metal, the p is 5 to 50.

6. The rare-earth magnet of claim 1, wherein in the composition of the diffusion metal, the q is greater than 10 and less than 40.

7. The rare-earth magnet of claim 1, wherein the diffusion metal is 6 to 12 parts by weight based on 100 parts by weight of the rare-earth magnet precursor.

8. The rare-earth magnet of claim 1, wherein the TM1 comprises at least one of Ti, Ga, Zn, Si, Al, Nb, Zr, Mn, V, W, Ta, Ge, Cu, Cr, Hf, Mo, P, C, Mg, Ag, or Au.

9. The rare-earth magnet of claim 1, wherein the x is 0.2 to 0.3.

10. The rare-earth magnet of claim 1, wherein the y is 12.52 to 13.61.

11. The rare-earth magnet of claim 1, wherein the z is 3 to 5.

12. The rare-earth magnet of claim 1, wherein the v is 5 to 10.

13. The rare-earth magnet of claim 1, wherein the w is 0.5 to 1.

14. The rare-earth magnet of claim 1, wherein the rare-earth magnet precursor is a hot deformed magnet.
